(19) United States
(12) Patent Application Publication
(10) Pub. No.: US 2013/0265625 A1
(43) Pub. Date: Oct. 10, 2013

(54) AUTOSTEREOSCOPIC 3D DISPLAY

(71) Applicants: Thomas Fäcke, Leverkusen (DE); Friedrich-Karl Bruder, Krefeld (DE); Rainer Hagen, Leverkusen (DE); Günther Walze, Koln (DE)

(72) Inventors: Thomas Fäcke, Leverkusen (DE); Friedrich-Karl Bruder, Krefeld (DE); Rainer Hagen, Leverkusen (DE); Günther Walze, Koln (DE)

(73) Assignee: BAYER INTELLECTUAL PROPERTY GMBH, Monheim (DE)

(21) Appl. No.: 13/823,098

(22) PCT Filed: Sep. 14, 2011
(86) PCT No.: PCT/EP11/65926

§ 371 Date: Jun. 4, 2013

(30) Foreign Application Priority Data
Sep. 17, 2010 (EP) 10177422.2

(51) Int. Cl. G02B 27/22

(52) U.S. Cl. CPC G02B 27/225
USPC 359/15

(57) ABSTRACT

The invention relates to an autostereoscopic 3D display (1), comprising an illumination unit (2) having two light sources (3, 4), a light guide (5), a holographic-optical element (6) as a diffractive optical light directing element, a transparent display panel (7), and a control unit (8) for alternately synchronizing the light sources (3, 4) with a right and a left parallactic image represented on the display panel (7), wherein the light sources (3, 4) are oriented so as to irradiate light into the light guide (5) from various directions and the holographic-optical element (6) and the display panel (7) are arranged such that light emitted by the light guide is diffracted by the holographic-optical element (6) in two different directions, depending in the preferred direction of the light, and directed through the display panel (7), wherein at least one surface of he light guide (5) has a refractive surface (10).

The present invention relates to an autostereoscopic 3D Display.

An autostereoscopic 3D display (ASD) is a screen which can display stereoscopic images, that is to say images that appear three-dimensional to one or more persons. Three-dimensional images are understood to be images which, in comparison with the conventional two-dimensional images, additionally have a depth effect. In the case of ASDs, in contrast to conventional stereoscopic displays, the viewer does not require aids such as spectacles, prism viewers or other optical aids.

In order to obtain a three-dimensional impression, in autostereoscopic displays, two images are projected such that, by means of parallax each eye sees a different image. In this case, the projection in two different directions has to be fashioned such that the images reach the eyes of the viewer as a stereo pair. In this case, the two projection directions are usually produced in the backlight unit of the display.

The developers of ASDs and the individual components thereof aim to enable images to be represented spatially in as realistic a manner as possible, and at the same time high ergonomics for the viewer. In this case, basic prerequisites for a realistic, high-quality image include a high image resolution (known high-definition 2D televisions—HDTV are the standard to be striven for here) and a high image frequency. Elements of 3D coding are additionally included. Good ergonomics are achieved by adapting the so-called sweet spot, the point of optimal stereoscopic effect, to the current position of one or more observers.

Two different technical solution approaches for achieving these aims are known, in principle, in the prior art: in accordance with the first approach, two projection directions can be realized, e.g. by lenses or prism grids which deflect the light of individual display pixels in different directions away from the screen. In this case, a vertical strip mask has individual vertical pixel strips that operate in a direction-selective manner. However, since there are left and right pixel strips in such an ASD, the image resolution is halved in comparison with a conventional 2D display. Furthermore, it is technically difficult to represent a 2D image with original resolution by means of corresponding configuration of the strip mask by means of a liquid crystal element (LCD). A further disadvantage for 2D representation is that the strip mask constitutes a parallactic barrier which blocks parts of the light rays and thus darkens the image.

A second approach concerns ASDs having two light sources and a synchronization unit, which display time-offset oscillating images with maximum resolution maintained. A prerequisite for a flicker-free image in such a light-transmissive ASD is a sufficiently high alternating frequency. However, this is realized nowadays in the prior art. Specific embodiments of this approach will be described in greater detail below.

US 2006/0164862 discloses an autostereoscopic display, containing two separate optical waveguides with prismatic, refractive deflection structures and also two light sources, a diffuser film, a transmissive display panel, light absorbers and reflectors.

US 2005/0264717 in turn discloses an autostereoscopic display having two separate light sources on an optical waveguide with prismatic, refractive deflection structures and also a second optical film, likewise with prismatic, refractive deflection structures and also a transmissive display panel.

Finally, US 2007/0276071 describes an autostereoscopic display, having two light sources positioned on different sides of an optical waveguide, a double-prismatic refractive light element and also a transmissive display panel. The double-prismatic refractive light element consists of a triangular prismatic structure, which faces the optical waveguide, and a spherical lens structure, which faces away from the optical waveguide. The two light sources are driven alternately by means of a synchronization unit in such a way that the transmissive display panel successively reproduces a right and a left stereoscopic image of a three-dimensional image content to be represented.

The autostereoscopic displays described above each have light directing elements with refractive deflection structures. When elements of this type are used, however, impairments of the image quality occur, which are attributable to refractive disturbing effects. The disturbing effects are caused, inter alia, by undesirable secondary light paths, multiple reflections, or moiré effects which are brought about by the interaction of parallel refractive optical structures. In the overall system, the disturbing effects can lead to banding, a reduction of resolution and/or inadequate separation of the channels for 3D representation in conjunction with general lack of definition. This can in turn cause the viewer's eyes to experience greater fatigue. Furthermore, distinct visual quality differences in relation to commercially available 2D HD TVs (High Definition television), can be discerned, which reduce the market acceptance of such autostereoscopic displays.

A further disadvantage when using light directing elements having a plurality of layers composed of refractive deflection structures is the difficulty in ensuring the necessary high lateral positioning accuracy of the individual refractive optical surface elements with respect to one another. If extremely small deviations occur here, separation into the two or more channels for 3D representation is hugely impaired. Moreover, in this case, optical disturbing effects possibly already present, such as e.g. Moiré effects, are intensified further.

It was an object of the invention, therefore, to provide an autostereoscopic 3D display which does not have the optical disturbing effects described and with which, therefore, a 3D representation that is improved with regard to the image quality can be obtained.

This object is achieved by means of an autostereoscopic 3D display comprising an illumination unit having two light sources, an optical waveguide, a holographic optical element as diffractive optical light directing element, a transparent display panel and a control unit in order to synchronize the light sources alternately respectively with a right and a left parallactic image represented on the display panel, with the light sources oriented for radiating light respectively from different directions into the optical waveguide and the holographic optical element and the display panel are arranged in such a way that light emitted from the optical waveguide depending on its preferred direction, is diffracted by the holographic optical element in two different directions and is directed through the display panel wherein at least one surface of the optical waveguide has a refractive surface.

In this case, the autostereoscopic 3D display according to the invention is intended primarily to avoid or reduce refractive optical disturbing effects to an extent such that the risk of eye fatigue states is significantly lowered. This becomes possible, in particular through the use of a holographic optical element which deflects the light such that the direction-specific channel division required for autostereoscopy is ensured. In this case, the number of channels can also turn out to be greater than two and either even or odd.

Furthermore, in the case of the autostereoscopic 3D display according to the invention, the stringent requirements made of the lateral positioning accuracy of the optical elements with respect to one another are obviated, which leads to significantly simplified producibility of this type of display.

The refractive surface of the optical waveguide has the effect that the angle bandwidth of the light that is emitted from the optical waveguide and is incident in the holographic optical element is narrow. This is advantageous since the diffraction efficiency of the holographic optical element becomes all the greater, the narrower said angle bandwidth around the coupling-in angle required for meeting the Bragg conditions. Thus, firstly, the diffraction efficiency of a holographic optical element based on volume holograms is all the greater, the greater the layer thickness of the volume hologram. Secondly, the angle selectivity increases, that is to say that the acceptable angle bandwidth around the Bragg condition decreases, for the volume hologram as the layer thickness increases. A narrowing of the angle bandwidth of the light incident on the holographic optical element is therefore advantageous because it enables a wider range of permissible layer thicknesses for producing high diffraction efficiencies. This is illustrated schematically in Figures I and II. Thus, Figure I shows an optical waveguide with a suitable prism structure that brings about a narrow angle bandwidth for the emitted light. Figure II illustrates an optical waveguide without a corresponding prism structure. The light is emitted from this optical waveguide with a wide angle bandwidth.

The refractive surface can have, in particular, linear translationally invariant prism structures, multidimensional pyramidal prism structures, linear translationally invariant lens structures based on ellipsoids, polynomials, circular cone segments, hyperbolas or combinations of these basic bodies, multidimensional hemispherical lens structures based on ellipsoids, polynomials, circular cone sections, hyperbolas or combinations or combinations of these basic bodies, non-periodic scattering surface structure, either applied areally or in regions in combination with non-scattering structures.

The refractive surface can be produced by means of embossing, wet embossing, injection moulding, extrusion, printing, laser structuring and other methods.

It is likewise possible for the autostereoscopic 3D display according to the invention additionally to have at least one optical film. The optical film can be, in particular, a diffuser film, microlens film, prism film, lenticular film or a reflection polarization film. It goes without saying, that a plurality of such films can also be present in the display.

It is particularly preferred, furthermore, if the holographic optical element is a volume hologram.

The holographic optical element can, in particular, also be embodied such that it produces a collimating or diverging angle distribution. Such a holographic optical element can be used, for example, for increasing the brightness at the location of the viewer, for addressing different viewers or for improving the 3D impression.

It is also further preferred if the holographic optical element is a transmissive and/or reflective hologram and/or a transmissive and/or reflective edge-lit hologram.

It is also possible for the holographic optical element to be constructed from a plurality of individual holograms connected to one another. In this case, the individual holograms can be in particular, volume holograms, which are in turn obtainable preferably by multiplexing and especially preferably by angle division multiplexing and/or wavelength division multiplexing. In this case, the individual holograms can serve for the left and right projections. Likewise, the individual holograms can in each case be specifically embodied such that they only diffract radiation of one of the three primary colours, red, green and blue. It is also possible to use more than three primary colours such as. e.g. four primary colours (e.g. “red”, “green”, “blue” and “yellow”). Finally, both effects can also be combined, such that, for example, six individual holograms are then used for each of the three primary colours and the two stereoscopic directions.

The production of such volume holograms is known (H. M. Smith in “Principles of Holography”, Wiley-Interscience 1969) and can be effected e.g. by means of two-beam interference (S. Benton, “Holographic Imaging”, John Wiley & Sons, 2008).

Methods for mass replication of reflection volume holograms are described in U.S. Pat. No. 6,824,929, wherein a light-sensitive material is positioned onto a master hologram and then coherent light is used to effect copying. The production of transmission holograms is likewise known. Thus, by way of example, U.S. Pat. No. 4,973,113 describes a method by means of roll replication.

In particular, reference should also be made to the production of edge-lit holograms, which require specific exposure geometries. In addition to the introduction by S. Benton (S. Benton, “Holographic Imaging”, John Wiley & Sons, 2008, Chapter 18) and an overview of traditional two- and three-stage production methods (see Q. Huang, H. Caulfield, SPIE Vol. 1600, International Symposium on Display Holography (1991), page 182), reference should also be made to WO 94/18603, which describes edge illumination and waveguiding holograms. Furthermore, reference should be made to the special production methods in WO 2006/111384, which describes a method on the basis of a specific optical adapter block.

Various materials are appropriate for the production of the volume holograms. Fine-grained silver halide emulsions or dichromate gelatines which require a wet-chemical development process after exposure are suitable. Furthermore, photopolymers are suitable, such as e.g. Omnidex® photopolymer film (from DuPont of Neymours), which necessitates thermal after treatment, and Bayfol® HX photopolymer film (from Bayer MaterialScience AG), which does not require further chemical or thermal aftertreatment for the complete development of the hologram. Ideal materials exhibit high transparency and low haze. Therefore, photopolymers are preferred for this application. Photopolymers that do not require thermal aftertreatment are particularly preferred.

The holographic optical element can preferably consist either of one layer having at least two holograms which were introduced by exposure by means of angle division multiplexing or wavelength division multiplexing, or of at least two layers laminated one above another and each having at least one hologram. A plurality of holograms per layer can in turn be obtained by angle division multiplexing or wavelength division multiplexing.

In order to optimize the homogeneous illumination, it is possible to vary the diffraction efficiency and/or the diffraction angle of the individual holograms in the layers over the width of the holographic optical element. This variation of the diffraction efficiency and/or the diffraction angles can be effected in steps and/or continuously.

In accordance with a further preferred embodiment, it is provided that the optical waveguide is a parallelepiped.

The optical waveguide can be produced by industrially conventional methods. Injection moulding methods and sheet extrusion methods are conventional in this case. Optically transparent plastics such as e.g. polymethyl methacrylate and polycarbonate are usually used as materials. The shaping is preferably implemented either by the injection mould in the injection moulding method or by die shape and possible hot embossing deformation by means of specifically shaped rollers in the sheet extrusion method.

However, it is also possible for the optical waveguide to have bevelled edges. This makes it possible to optimize the coupling-in of the light and the illumination angles then obtained.

The light sources can be, in particular, gas discharge lamps, preferably cold gas discharge lamps, light-emitting diodes, preferably red, green, blue, yellow and/or white light-emitting diodes and/or a plurality of laser diodes.

The light emitted by the light sources can have a broad spectral distribution of the wavelengths (white light) or a band spectrum. In the extreme case, monochromatic light can even be involved. It is preferred, however, if the light sources emit light having a band emission spectrum.

It is preferred if the light sources are arranged at two opposite side surfaces of the parallelepiped.

The light sources can be in direct contact (linearly or areally) with the side surfaces of the parallelepiped or adjacent thereto.

It is likewise possible to fit a refractive or diffractive optical element on the optical waveguide in order to make the optical coupling-in of the light into the holographic optical element more efficient and/or more angle- or frequency-selective.

Thus, prism structures having the same (or virtually the same) refractive index as the optical waveguide are also suitable for this purpose. In this case, the light sources are positioned in such a way that the light is coupled in as far as possible in a manner avoiding partial or total reflection. Refractive optical elements can also be concomitantly produced directly during the production of the optical waveguide itself. Diffractive optical elements can be embodied as a volume or embossing hologram (a thin transmission hologram that can be produced by means of an embossing, wet embossing, or e.g. by means of a lithographic process).

In one preferred autostereoscopic 3D display, it is provided that the holographic optical element, the optical waveguide and the display panel are arranged in one of the following orders: a) holographic optical element, optical waveguide and display panel or b) optical waveguide, holographic optical element, display panel. In this case, the holographic optical element, the optical waveguide and the display can be connected to one another areally.

However, the holographic optical element can also be positioned in a manner either directly adjoining or at a distance from the optical waveguide in a self-supporting fashion.

Likewise, the display panel can be positioned in a manner either directly adjoining or at a distance from the optical waveguide in a self-supporting fashion.

The invention is explained in greater detail below with reference to the drawings. In the drawings:

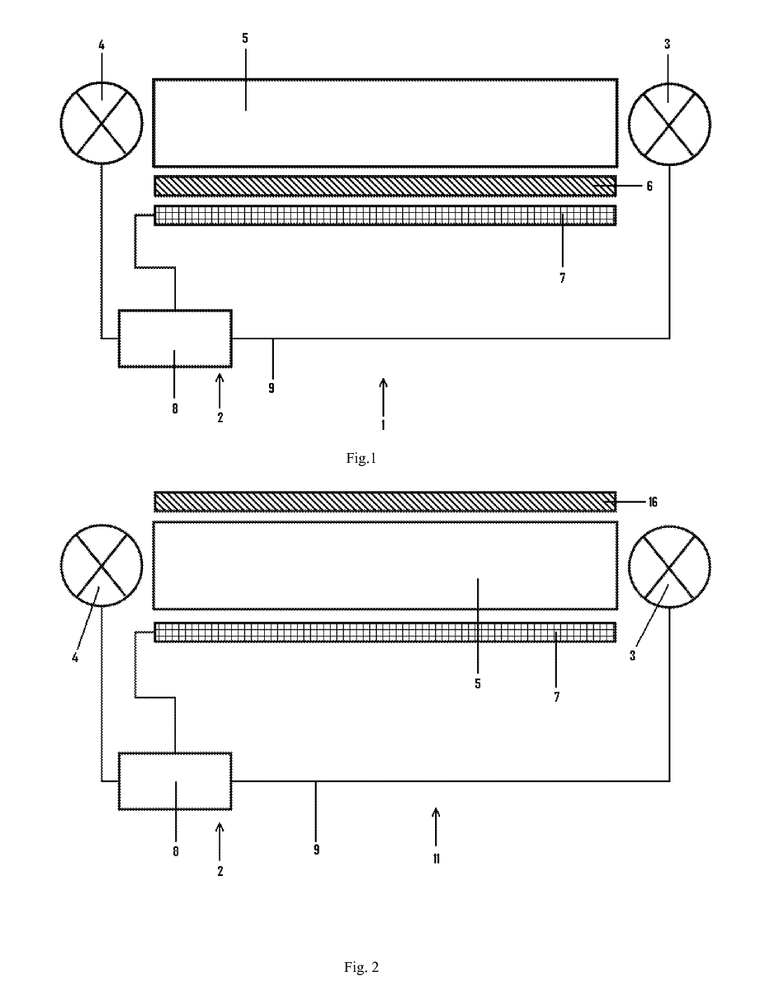

FIG. 1 shows a schematic plan view of a first embodiment of the invention,

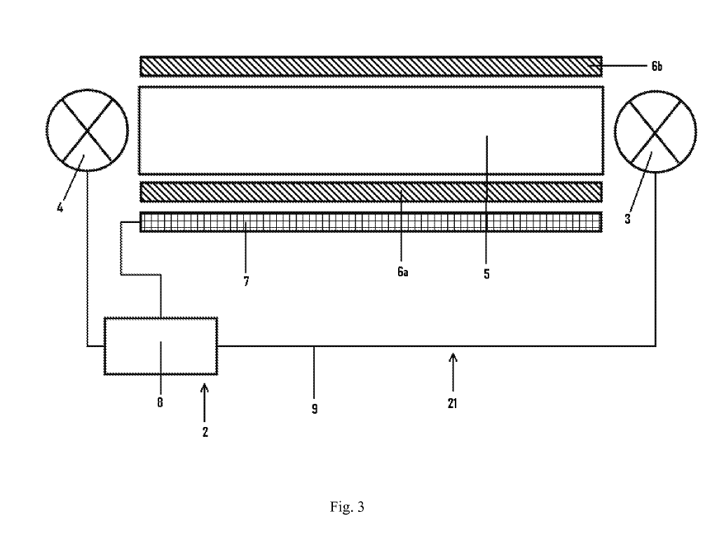

FIG. 2 shows a schematic plan view of a second embodiment of the invention,

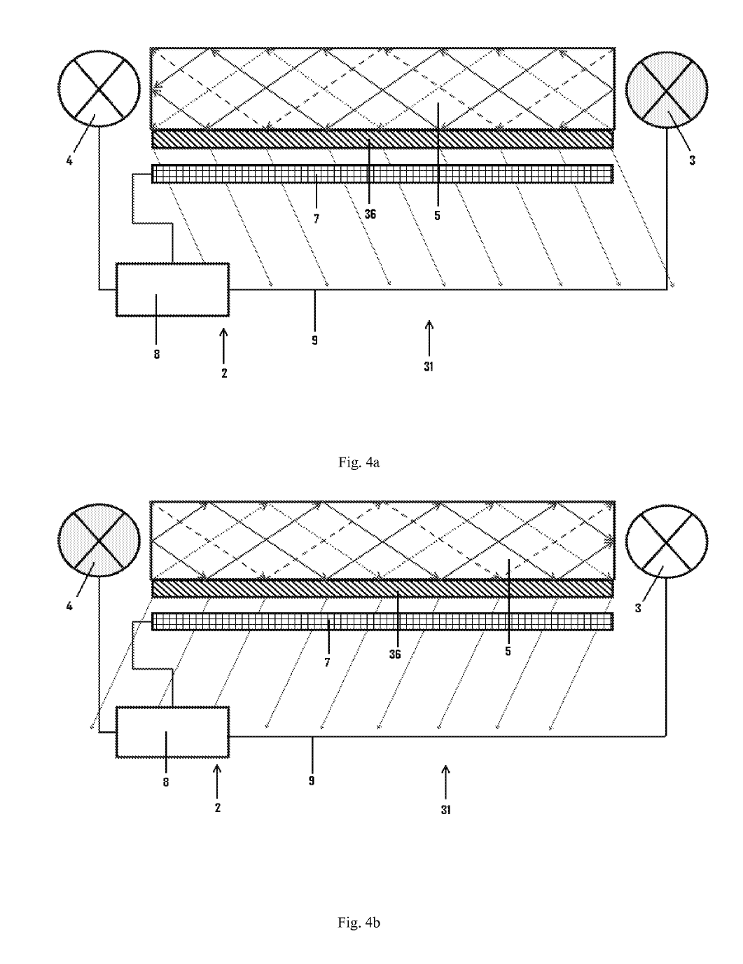

FIG. 3 shows a schematic plan view of a third embodiment of the invention,

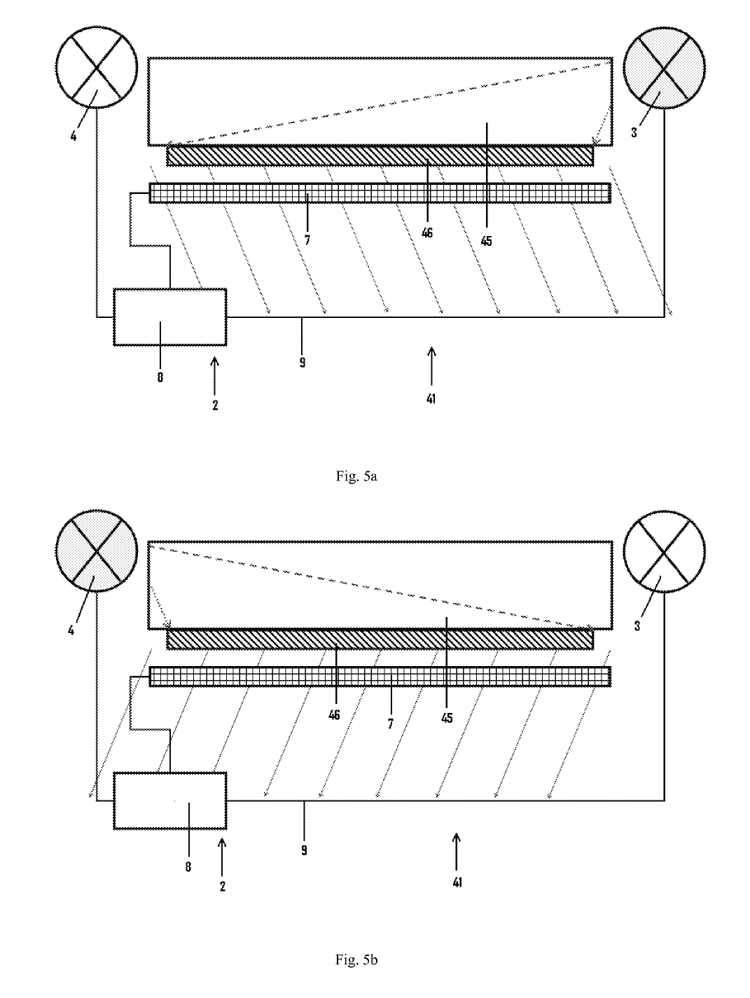

FIG. 4a shows a schematic plan view of a fourth embodiment of the invention in operation,

FIG. 4b shows a schematic plan view of the fourth embodiment of the invention in operation,

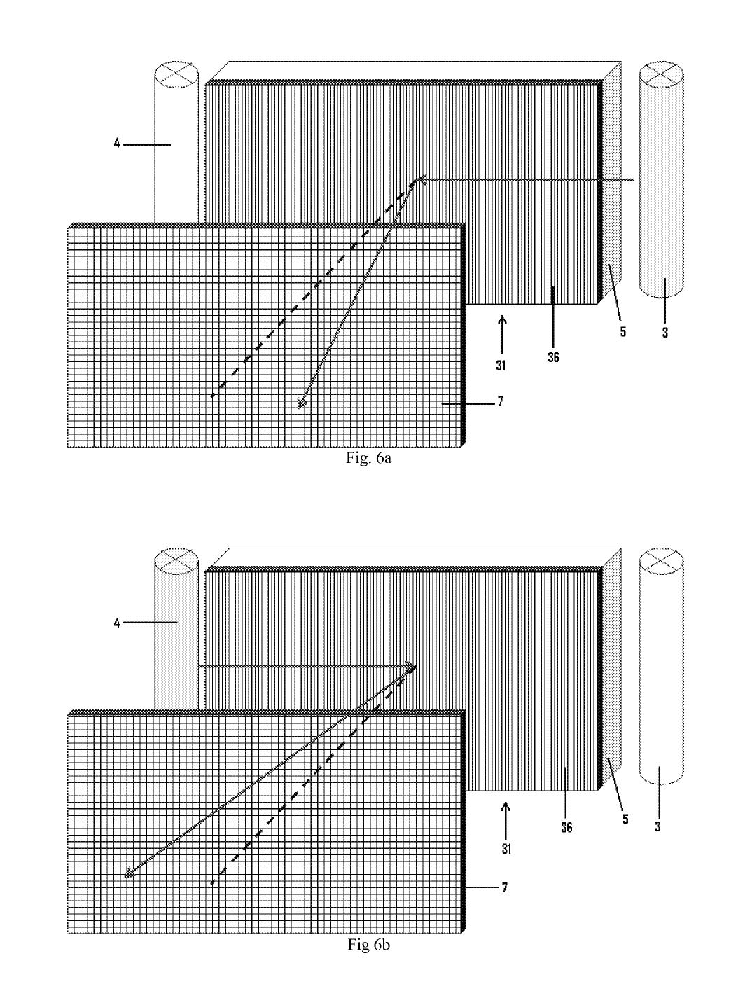

FIG. 5a shows a schematic plan view of a fifth embodiment of the invention in operation,

FIG. 5b shows a schematic plan view of the fifth embodiment of the invention in operation,

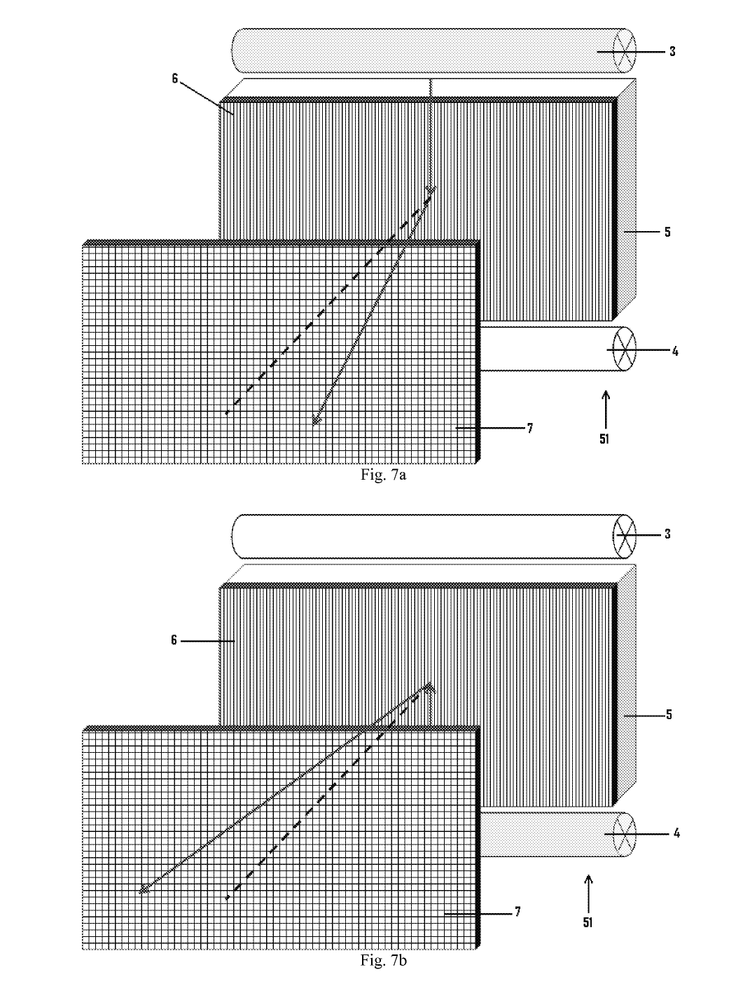

FIG. 6a shows a perspective view of the first embodiment of the invention in operation,

FIG. 6b shows a further perspective view of the first embodiment of the invention in operation,

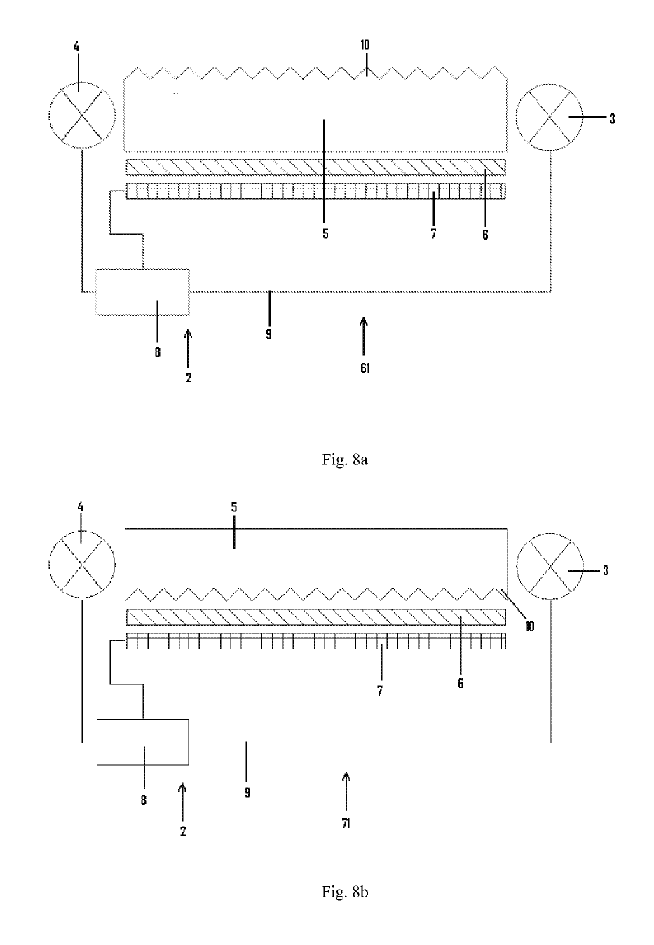

FIG. 7a shows a perspective view of a sixth embodiment of the invention in operation,

FIG. 7b shows a further perspective view of the sixth embodiment of the invention in operation,

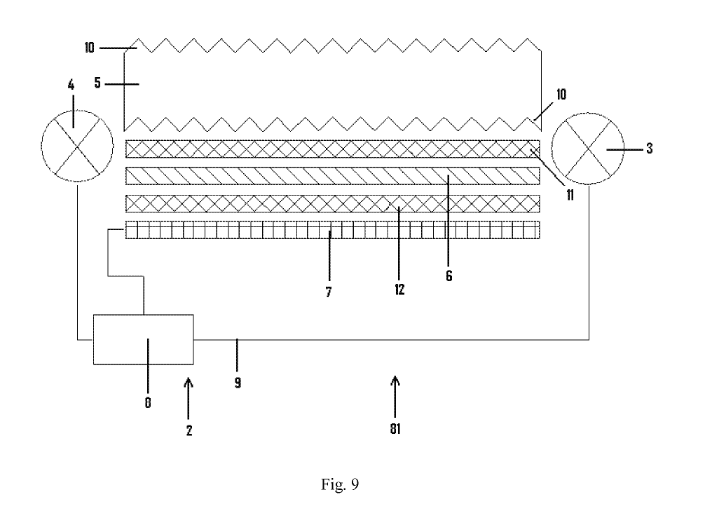

FIG. 8a shows a schematic plan view of a seventh embodiment of the invention,

FIG. 8b shows a schematic plan view of an eighth embodiment of the invention, and

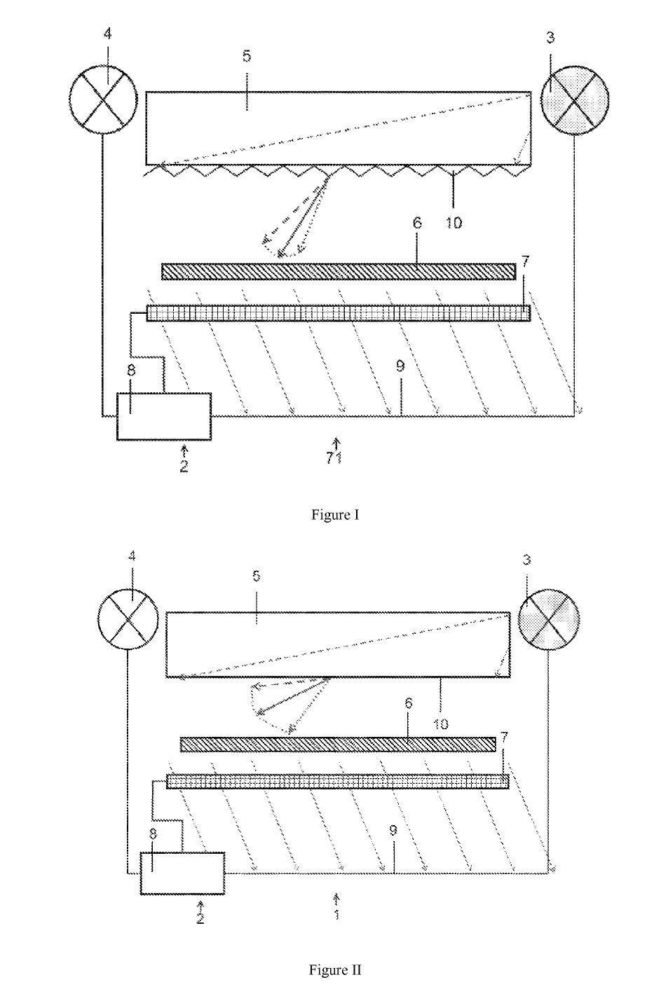

FIG. 9 shows a schematic plan view of a ninth embodiment of the invention.

FIG. 1 schematically illustrates a first embodiment of an autostereoscopic 3D display (ASD) according to the invention in plan view. The ASD 1 shown here comprises an illumination unit 2 having two light sources 3 and 4, a parallelepipedal optical waveguide 5, a holographic optical element 6 as diffractive optical element, a transparent display panel 7 and also a control unit 8. The display panel 7 can be, for example, a light-transmissive LCD display known in the prior art. The control unit 8 is connected to the lamps 3 and 4 and the display panel 7 via electrical leads 9. The light sources 3 and 4 are oriented and arranged such that they radiate light from respectively different directions, i.e. once from the right and once from the left, into the side surfaces of the parallelepipedal optical waveguide 5 respectively lying opposite them. The holographic optical element 6 and the display panel 7 are in turn arranged in this order in the plane of the drawing below and parallel to the optical waveguide 5. The holographic optical element 6 is embodied here as a transmission hologram. Holograms of this type are described, for example in P. Hariharan, Optical Holography, Cambridge Studies in Modern Optics, Cambridge University Press, 1996.

During the operation of the ASD 1, the light sources 3 and 4 are synchronized with a right and a left parallactic image, represented by the display panel 7, by the control unit 8 in each case with a high frequency of greater than 50 hertz. Optimized switching cycles for the control unit are described in WO 2008/003563, for example.

The light from the light sources 3, 4 enters into the optical waveguide 5, is reflected at that interface of the optical waveguide 5 which is illustrated at the top in the plane of the drawing, and is coupled out at the opposite underside of the optical waveguide 5. The light thus emitted from the optical waveguide 5 in the direction of the holographic optical element 6 has a different preferred direction depending on whether it originates from the right light source 3 or the left light source 4, and is then correspondingly diffracted by the holographic element in two different directions and directed onto the display panel 7.

In this way, the ASD 1 alternately generates two parallactic images, of which one is respectively perceived by the right eye and one by the left eye of a viewer, as a result of which a high-quality three-dimensional image with full resolution arises for said viewer.

It is likewise possible for the holographic optical element 6 to be constructed from a plurality of individual holograms which are positioned in layers in a manner lying one on top of another or at a distance from one another. It is likewise possible for the holographic optical element 6 to be designed to diffract in each case only light of one colour (that is to say in a specific narrowed frequency range of the light visible to humans) or in each case only light from one light source, or indeed only one colour and/or only light from one direction.

FIG. 2 shows an alternative variant of the ASD 1 from FIG. 1 in plan view. Differences are that here the holographic optical element 6 is arranged in the plane of the drawing above the optical waveguide 5 rather than between optical waveguide 5 and display panel 7, and that the holographic optical element 16 here is a reflection hologram instead of a transmission hologram.

In the case of this ASD 11, the optical waveguide 5 emits the light radiated into it in the direction of the holographic optical element 6, where it is then diffracted back into the optical waveguide 5. After passing through the optical waveguide 5, it then impinges on the display panel 7.

FIG. 3 shows yet another variant of the construction shown in FIG. 1. Here, two holographic optical elements 6a and 6b are present, wherein the holographic optical element 6a corresponds in terms of arrangement and function to the holographic optical element 6 of the ASD 1 from FIG. 1 and the holographic optical element 6b corresponds in terms of arrangement and function to the holographic optical element 16 from ASD 1 from FIG. 2. Consequently, the ASD 21 from FIG. 3 has both a transmission hologram (6a) and a reflection hologram (6b).

During the operation of the ASD 21 in FIG. 3 in a switching cycle, firstly light emerges from the light source 4, while the light source 3 does not emit light. The light enters into the optical waveguide 5 and from there into the holographic optical element 6a and is diffracted there in the direction of the display panel 7. The control unit 8 now switches off the light source 4 and then switches on the light source 3 simultaneously or with a slight temporal overlap or with a temporal separation. The light emerging from the light source 3 is diffracted via the optical waveguide 5 through the holographic optical element 6b in the direction of the display panel 7, wherein it is not or not significantly deflected by the optical waveguide 5 and the holographic optical element 6a. In the two switching cycles, the light from the ASD 21 respectively reaches the left and right eye of the viewer.

It is likewise possible to interchange the light guiding sequence of the holographic optical elements 6a and 6b. It is likewise possible for each of the holographic optical elements 6a and 6b to have a diffractive effect for in each case only one colour or else a plurality of colours, that is to say that the light guiding sequence e.g. for two colours is effected by the holographic optical element 6a for “red” light and by the holographic optical element 6b for “green” and “blue” light. Other combinations are likewise possible. It can be advantageous here if the light sources 3 and 4 consist of different structural units which respectively emit the primary colours and are positioned slightly differently vertically with respect to one another. Furthermore, it is possible of course, for the two holographic optical elements 6a and 6b to have a diffractive effect for light guided from the light sources 3 and 4 and through the optical waveguide 5 and to project a respective one of the two stereoscopic images into the respective eye of the viewer through the display panel 5. This procedure has the advantage of a higher luminous efficiency.

FIGS. 4a and 4b show once again in plan view a variant of the ASD 1 from FIG. 1 during operation. In this case, FIG. 4a shows a switching state in which the right light source 3 emits light into the optical waveguide 5 and FIG. 4b shows a state in which the light source 4 is activated.

One difference between the ASD 1 from FIG. 1 and the device 31 from FIGS. 4a and 4b is that, in the case of the ASD 31, the holographic optical element 36 is areally connected directly to the optical waveguide 5. Moreover, in the case of the ASD 31 the holographic optical element 36 is embodied as a transmission edge-lit hologram.

It is likewise possible for the holographic optical element 36 to be constructed from a plurality of individual holograms which are positioned in layers in a manner lying one on top of another or at a distance from one another. It is likewise possible for the holographic optical element to be designed to diffract in each case only light of one colour (that is to say in a specific narrowed frequency range of the light visible to humans) or in each case only light from one light source, or indeed only one colour and/or only light from one direction.

FIGS. 5a and 5b show a modification of the ASD 31 from FIGS. 4a, 4b. Here, firstly the light sources 3 and 4 are displaced somewhat further upwards in the plane of the drawing, and secondly an optical waveguide 45 is used in which the (total) reflection of the light radiated in hardly occurs in the interior, rather said light is guided directly through the optical waveguide 45 to the holographic optical element 46. The holographic optical element 46 (a transmission edge-lit hologram) is embodied in such a way that it diffracts the light originating from the optical waveguide 45 once again depending on the preferred direction thereof in two different directions and directs it onto the display panel 7.

FIGS. 6a and 6b are perspective illustrations of the ASD 31 from FIGS. 4a and 4b in operation. FIG. 6a shows the state of the ASD 31 with an activated light source 3, and in FIG. 6b the left light source 4 is active. The path of a light beam from one of the light sources 3 or 4 through the optical waveguide 5 to the holographic optical element 36 and with diffraction by the holographic optical element 36 onto the display panel 7 is shown by way of example in each case. The holographic optical element 6 is in this case designed such that diffraction is effected in a plane lying parallel to the plane spanned by the pair of eyes of a viewer with the normal to the surface of the display panel 7.

FIGS. 7a and 7b perspectively illustrate as a sixth embodiment of the invention a variant of the ASD 31 from FIGS. 4a and 4b in operation. The difference here is that the light sources 3 and 4 are not arranged on the right and left alongside the optical waveguide 5 but rather above and below the latter. Here, moreover, the holographic optical element 56 is designed such that diffraction is effected in a plane lying perpendicular to the plane spanned by the pair of eyes of a viewer with the normal to the surface of the display panel 7.

In principle, a combination of the embodiments in FIGS. 6a, 6b and 7a, 7b is also possible.

FIG. 8a shows a seventh embodiment of an ASD according to the invention. This ASD corresponds to the ASD 1 from FIG. 1 apart from one deviation. The only difference is that the optical waveguide 5 is provided with a refractive surface structure 10 at the upper side in the plane of the drawing.

During the operation of the ASD 61, the surface structure 10 has the effect that an even greater portion of the light radiated in can be reflected in the optical waveguide 5 and then be emitted in the direction of the holographic optical element 6.

Furthermore, it can be advantageous for the surface structure 10 to be reflectively coated e.g. by means of a vacuum metallization method in order, for instance, to enable more homogeneous illumination and/or an improved brightness of the ASD 61.

In the case of the ASD 61, too, it is possible for the holographic optical element 6 to adjoin the optical waveguide 5 directly or the display panel 7 directly.

FIG. 8b shows a variant of ASD 61 from FIG. 8a, in which the refractive surface structure 10 is arranged at the lower side of the optical waveguide 5 in the plane of the drawing. This has the effect that the light is coupled out in a targeted manner from the optical waveguide 5 more efficiently and then deflected by means of the holographic optical element 6. In this way, the brightness of the ASD 71 is increased and more homogeneous illumination of the ASD occurs.

Finally, a ninth embodiment of the ASD according to the invention is shown schematically in plan view in FIG. 9. The ASD 81 illustrated here is based on the device form FIG. 1 in terms of its construction. However, here two optical films 11 and 12 are additionally present, wherein one film is arranged between the optical waveguide 5 and the holographic optical element 6 and one film is arranged between the holographic optical element 6 and the display panel 7. The films 11, 12, independently of one another, can be diffuser films, microlens films, prism films, lenticular films or reflection polarization films. Furthermore, the optical waveguide 5 of the ASD 81 differs from the ASD 1 from FIG. 1 in that it is provided with a refractive surface structure 10 both at the upper side and at the lower side in the plane of the drawing.

The use of the optical films 11 and 12 and the presence of the refractive surfaces 10 lead to homogenization or improvement of the luminous efficiency.

In the design of the ASD 1 and the designs of ASD 31, 41, 51, 61, 71 and 81 derived therefrom it can be advantageous for that side of the optical waveguide which respectively faces away from the display panel to be configured predominantly in reflective fashion, or to be reflectively coated. This makes it possible to realize a higher brightness of the display and more homogeneous illumination.

### LIST OF REFERENCE SYMBOLS

(1,11,21,31,41,51,61,71,81) ASD

(2) Illumination unit

(3) Light source

(4) Light source

(5, 45) Optical waveguide

(6, 6a, 6b, 16, 36, 46, 56) Holographic optical element

(7) Display panel

(8) Control unit

(9) Electrical lead

(10) Refractive surface

(11, 12) Optical films

1. An utostereoscopic 3D display comprising an illumination unit comprising two light sources, an optical waveguide, a holographic optical element as diffractive optical light directing element, a transparent display panel and a control unit in order to synchronize the light sources alternately respectively with a right and a left parallactic image represented on the display panel, with the light sources, oriented for radiating light respectively from different directions into the optical waveguide and the holographic optical element and the display panel are arranged in such a way that light emitted from the optical waveguide depending on a preferred direction thereof, is diffracted by the holographic optical element in two different directions and is directed through the display panel wherein at least one surface of the optical waveguide refractive surface.

2. The autostereoscopic 3D display according to claim 1, wherein said refractive surface has one or more linear translationally invariant prism structures, multi-dimensional pyramidal prism structures, linear translationally invariant lens structures based on ellipsoids, polynomials, circular cone segments, hyperbolas and/or combinations of basic bodies, multidimensional hemispherical lens structures based on ellipsoids, polynomials, circular cone sections, hyperbolas or combinations or combinations of these basic bodies, non-periodic scattering surface structure, either applied areally and/or in regions in combination with non-scattering structures.

3. The autostereoscopic 3D display according to claim 1, wherein said autostereoscopic 3D display comprises at least one optical film.

4. The autostereoscopic 3D display according to claim 3, wherein said optical film comprises a diffuser film, microlens film, prism film, lenticular film and/or a reflection polarization film.

5. The autostereoscopic 3D display according to claim 1, wherein said holographic optical element comprises a volume hologram.

6. The autostereoscopic 3D display according to claim 1, wherein said holographic optical element is embodied such that said holographic optical element produces a collimating and/or diverging angle distribution.

7. The autostereoscopic 3D display according to claim 1, wherein said holographic optical element is a transmissive and/or reflective hologram and/or a transmissive and/or reflective edge-lit hologram.

8. The autostereoscopic 3D display according to claim 1, wherein said holographic optical element is constructed from a plurality of individual holograms connected to one another in an adjoining fashion.

9. The autostereoscopic 3D display according to claim 1, wherein said holographic optical element or individual holograms connected to one another comprise volume holograms that are obtainable optionally by multiplexing and/or optionally by angle division multiplexing and/or wavelength division multiplexing.

10. The autostereoscopic 3D display according to the claim 1, wherein said optical waveguide is a parallelepiped.

11. The autostereoscopic 3D display according to claim 1, wherein said light sources comprise gas discharge lamps, optionally cold gas discharge lamps, light-emitting diodes, optionally red, green, blue, yellow and/or white light-emitting diodes and/or laser diodes.

12. The autostereoscopic 3D display according to claim 10, wherein said light sources are arranged at two opposite side surfaces of the parallelepiped.

13. The autostereoscopic 3D display according to claim 10, wherein said holographic optical element, the optical waveguide and the display panel are arranged in one of the following orders: holographic optical element, optical waveguide and display panel or optical waveguide, holographic optical element, display panel.

14. The autostereoscopic 3D display according to claim 13, wherein said holographic optical element, the optical waveguide and the display are connected to one another areally.
